(19) United States
(12) Patent Application Publication
(10) Pub. No.: US 2005/0232235 A1
(43) Pub. Date: Oct. 20, 2005

(54) Method and system for providing an interface between switching equipment and 2G wireless interworking function

(75) Inventors: Abhishek Sharma, Streamwood, IL (US); Anuranjan Gulati, Streamwood, IL (US); Eric Erickson, Mount Prospect, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Alameda, CA (US)

(21) Appl. No.: 10/824,164

(22) Filed: Apr. 14, 2004

(51) Int. Cl. H04L 12/56; H04L 12/66; H04Q 7/24; H04L 12/28; H04Q 7/00

(52) U.S. Cl. 370/352; 370/328; 370/401; 370/338

(57) ABSTRACT

An Ethernet link connects a wireless switch and an interworking function (IWF). Both signaling information and bearer data are exchanged over the Ethernet link. The Ethernet-based interface enables wireless switch companies to keep their 2G customer base without having to deploy additional third party equipment. In order to make the Ethernet link function, an IWF chassis is modified to connect an Access Router card to a PRI card. The Access Router card packetizes and de-packetizes data to and from the PSTN. Additionally, a protocol is implemented between an application card and the Access Router card so that the application card can communicate signaling information to the Access Router card.

### BACKGROUND

1. Field

This invention relates to communication networks and more particularly to a method and system for providing an Ethernet-based interface between switching equipment and a G Wireless Interworking Function.

2. Description of Related Art

In a 2G Code Division Multiple Access (“CDMA”) wireless network, an Interworking Function (“IWF”) provides an interface between wireless data networks and data packet networks, such as the Internet and corporate intranets. The IWF also provides an interface between wireless data networks and wireline networks, such as the Public Switched Telephone Network (“PSTN”). The IWF may convert and send data to the data packet network or the PSTN depending on data type.

The IWF is connected to a wireless switch, such as a Mobile Switching Center (“MSC”), in the wireless network. The MSC is a switching device that provides services and coordination between mobile users in a wireless network and external networks, such as the PSTN and the Internet.

As the wireless market continues to grow, a strain is placed on the capabilities and resources of the wireless network. Many wireless switch vendors are migrating to 3G networks, which offer greater capacity and higher data rates, to overcome these problems. The 3G networks provide voice, data, and multimedia services over a data packet network. Additionally, the 3G networks decouple the switching and call control within the MSC into separate elements. A media gateway provides switching, while a wireless soft-switch provides call control. The wireless soft-switches may also be implemented in 2G networks.

However, not all wireless switch vendors have migrated to the 3G network standards or have implemented soft-switch solutions. Accordingly, there is a need to provide an IWF that can provide an interface to both wireless switch vendors using IP technology and the wireless switch vendors using 2G CDMA technology. By providing such an interface, the wireless switch vendors may implement the newer IP-based signaling and bearer interfaces for next generation technologies, without losing the ability to communicate with users of 2G CDMA technology.

### SUMMARY

A system and method for providing an interface between a wireless switch and an interworking function is provided. An Ethernet link connects the wireless switch and the interworking function. Both signaling information and bearer data are transmitted over the Ethernet link between the wireless switch and the interworking function.

An interworking function chassis includes an Access Router card connected to a Primary Rate Interface card. The Access Router card functions to translate bearer data between a wireless network and a Public Switched Telephone Network. The interworking function chassis also includes an application card. The application card provides signaling information to the Access Router card using a protocol. The protocol provides a method of transferring trunk, port, and IP address information from the application card to the Access Router card. Beneficially, the interworking function chassis can be used for interconnecting with IP soft-switches without changing the basic 2G data service implementation.

These as well as other aspects and advantages of the present invention will become apparent to those of ordinary skill in the art by reading the following detailed description, with appropriate reference to the accompanying drawings. Further, it is understood that this summary is merely an example and is not intended to limit the scope of the invention as claimed.

### BRIEF DESCRIPTION OF THE DRAWINGS

Presently preferred embodiments are described with reference to the following drawings, wherein:

FIG. 1 is a block diagram illustrating a typical connection scheme between a wireless switch and an IWF;

FIG. 2 is a block diagram illustrating a hybrid connection scheme between a wireless switch and an IWF;

FIG. 3 is a block diagram illustrating network architecture for describing an exemplary connection scheme between a wireless switch and an IWF;

FIG. 4 is a block diagram illustrating a connection scheme between a wireless switch and an IWF, according to an embodiment;

FIG. 5 is a top view of an IWF chassis, according to an embodiment;

FIG. 6 is a signaling call flow diagram illustrating signaling flow through the IWF chassis depicted in FIG. 5, according to an embodiment;

FIG. 7 is an example message format for a protocol used to communicate signaling information, and

FIG. 8 is a data call flow diagram illustrating data flow through the IWF chassis depicted in FIG. 5, according to an embodiment.

### DETAILED DESCRIPTION

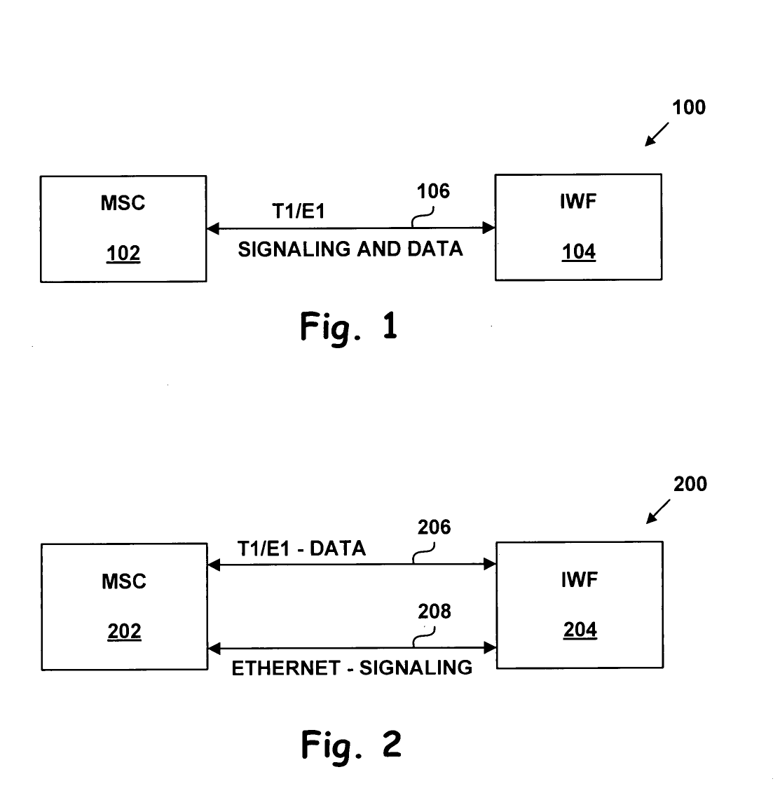

FIG. 1 is a block diagram 100 illustrating a typical connection scheme between an MSC 102 and an IWF 104. While the term MSC is used, it is understood that any switching equipment that provides data call connectivity may be used. The IWF 104 typically connects to the MSC 102 via T1/E1 links 106 for both signaling information and bearer data. One set of T1/E1 links are used for the mobile side of the call and a separate set of T1/E1 links are used for providing connectivity to the PSTN. Usually the signaling information travels on the T1/E1 links 106 either in-band or on dedicated DS0 channels.

FIG. 2 is a block diagram 200 illustrating a hybrid connection scheme between an MSC 202 and an IWF 204. Certain switch vendors use the hybrid connection scheme in which the signaling information is exchanged over an Ethernet link 208 using a User Datagram Protocol/Internet Protocol (“UDP/IP”) based signaling protocol, and the bearer data is exchanged over the T1/E1 links 206. The signaling interfaces are mostly Frame Relay Switched Virtual Circuit/Integrated Services Digital Network (“FRSVC/ISDN”) based and use Q.931 type information elements and signaling.

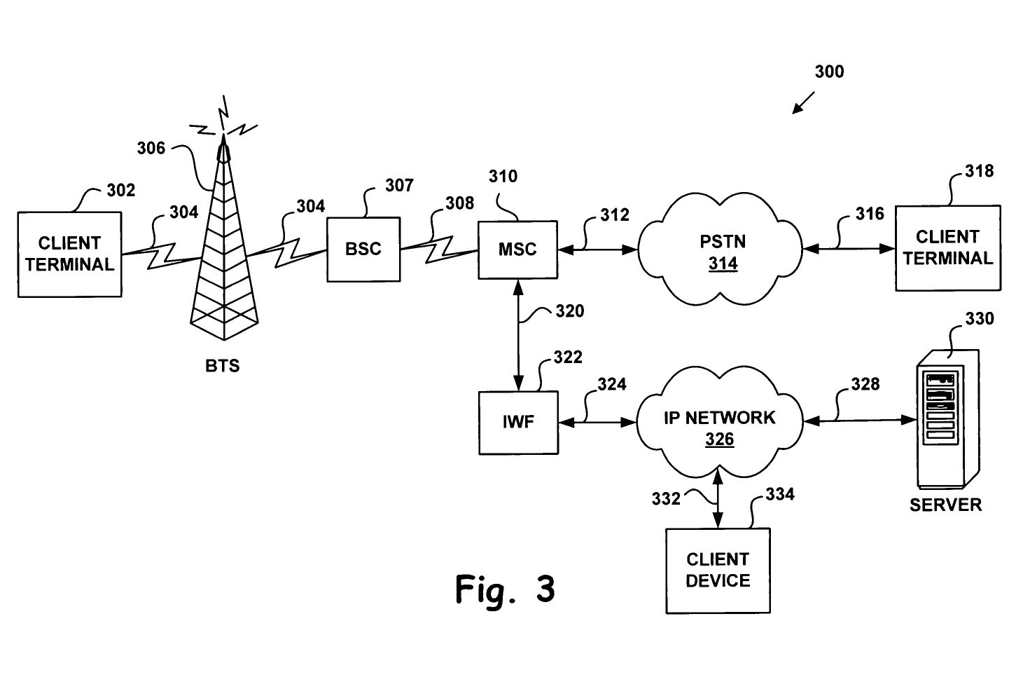

FIG. 3 is a block diagram illustrating network architecture 300 for describing an exemplary connection scheme between a wireless switch and an IWF. A client terminal 302 communicates over an air interface 304 via a Base Transceiver Station (“BTS”) 306. The BTS 306 performs radio resource management tasks for its given coverage area. The BTS 306 communicates with a Base Station Controller (“BSC”) 307 over the air interface 304. The BSC 307 manages the power levels and frequencies transmitted by the BTSs under its control, including the BTS 306, and may also control handoffs between BTSs. The combination of the BTS 306 and the BSC 307 may function to transmit voice and data traffic between wireless devices.

The BSC 307 is in turn coupled via a communication link 308 to an MSC 310, which serves to connect calls between various points in a network. The communication link 308 may include a Primary Rate Interface (“PRI”) employing a plurality of communication and control channels, which are carried over T1 and/or E1 carrier lines. The MSC 310 is further connected by a voice data link 312 to a PSTN 314, which provides a path through which the MSC 310 may connect calls with a remote MSC and in turn with another client device, or a client device that may access the PSTN 314 via a modem connection 316, such as a client terminal 318 illustrated in FIG. 3.

Further, as illustrated in FIG. 3, the MSC 310 is in turn coupled via a communication link 320 to an IWF 322. The IWF 322 is a hardware/software platform that serves as a gateway between a wireless network and a data packet network. The IWF 322 provides access to an IP network 326 and to the PSTN 314. The IWF 322 may reside within a service provider's central office or switching center and may connect directly to wireless switches.

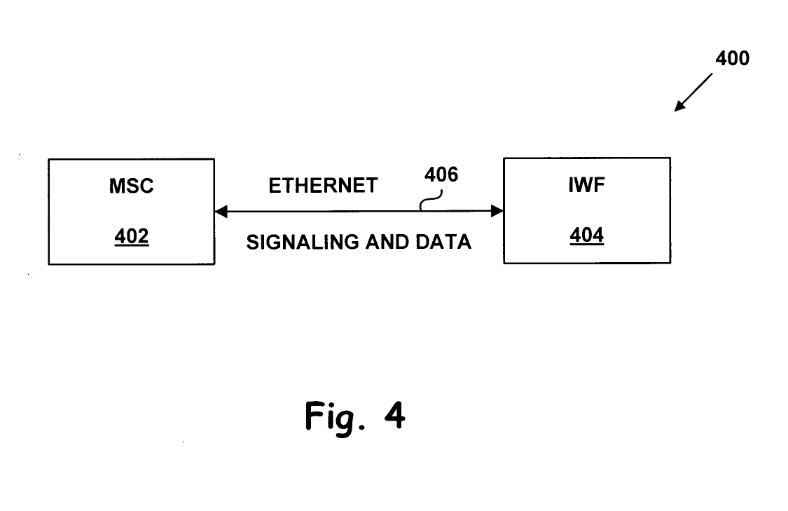

As illustrated in FIG. 3, the IWF 322 is coupled to the IP network 326 via a communication link 324 including, for example, an IP over Ethernet communication link. The IP network 326 may further provide communication links to other network entities or client devices. For example, the IP network 326 is coupled via a communication link 328 to a network server 330 and is coupled via a communication link 332 to a client device 334. The connection 320 between the MSC 310 and the IWF 322 is described in detail with reference to FIG. 4.

In the network architecture 300, the call processing on the MSC 310 depends on call setup and management data received from the BSC 306. If the call is identified as a regular voice call, then the MSC 310 may initiate Signaling System 7 (“SS7”) signaling to seize a trunk on an outgoing PRI to the PSTN 314. However, if a call is identified as a data or fax call, the MSC 310 switches the call to the IWF 322 over the connection 320. Subsequently, the IWF 322 may convert the incoming circuit call into IP data packets that are sent to a destination via the IP network 326. Alternatively, the data packets may be sent back to the MSC 310 to be transmitted to the PSTN 314 as a regular modem call over a T1/E1 PRI interface.

FIG. 4 is a block diagram illustrating a connection scheme between an MSC 402 and an IWF 404. An Ethernet link 406 connects the MSC 402 and the IWF 404. Both signaling information and bearer data are exchanged over the Ethernet link 406. By making minimal changes to the IWF 404, the IWF 404 may provide an Ethernet-based interface to the MSC 402. The Ethernet-based interface allows wireless switch companies to implement the newer IP-based signaling and bearer interfaces for next generation technologies, while keeping their 2G customer base without having to deploy additional third party equipment.

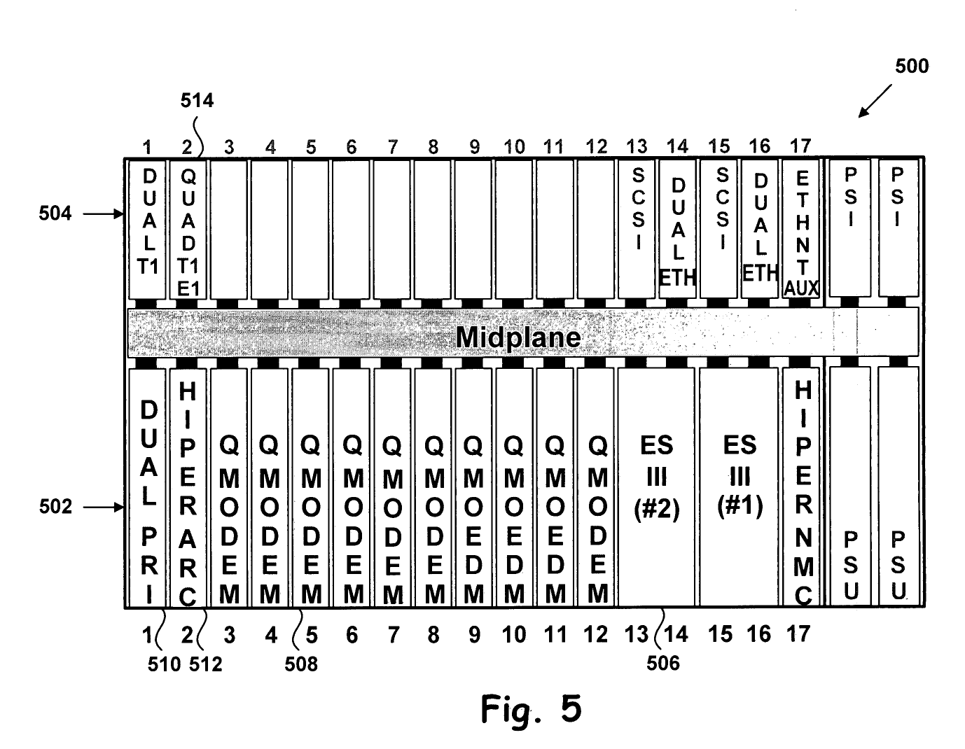

FIG. 5 is a block diagram illustrating an IWF chassis 500, according to an exemplary embodiment. The IWF 500 is a mid-plane based chassis having a front plane 502 and a back plane 504. The front plane 502 includes several circuit card slots in which network access cards (“NACs”) may be inserted. The back plane 504 includes several circuit card slots in which network interface cards (“NICs”) may be inserted. The NICs may provide connectivity to the IWF 500, while the NACs provide the functionality or the “brains” to the IWF 500.

The IWF chassis 500 includes several types of circuit cards. EdgeServer cards 506 are Windows NT based application cards that handle signaling and data forwarding functions for the 2G data service. The EdgeServer cards 506 provide call control functions within the IWF chassis 500. While the EdgeServer cards 506 are depicted in the IWF chassis 500, other application cards may be used to provide call control functions.

Quad Modem cards 508 provide modem functionality. Each Quad Modem card 508 supports four physical modems. While Quad Modem cards are described, other modem cards having more or less than four physical modems may be used.

A Dual PRI card 510 provides T1/E1 connectivity. Additionally, the Dual PRI card 510 includes two external T1/E1 interfaces. While Dual PRI 510 cards are described, other PRI cards having more or less than two T1/E1 interfaces may be used.

A High Performance Access Router card (“HiPerARC” or “HARC”) 512 may provide Layer 2 Tunneling Protocol (“L2TP”) functionality to 2G data users. The HARC card 512 functions to translate data messages to and from the PSTN. More specifically, the HARC card 512 packetizes data messages to be sent to the PSTN over an Ethernet link, while de-packetizing data received from the PSTN over an Ethernet link to be delivered to the Quad Modem cards 508 in the IWF chassis 500.

The HARC card 512 may be connected to a Quad T1/E1 NIC card 514 in the IWF chassis 500. PSTN data entering or leaving the HARC card 512 may enter or leave through the Quad T1/E1 NIC card 514. Alternatively, the functions of the Quad T1/E1 NIC card 514 may be integrated into the HARC card 512. While a Quad T1/E1 NIC card is described, other NICs having more or less than four T1/E1 connections may be used.

The HARC card 512 may be connected to the Dual PRI card 510 in the IWF chassis 500. The connection between the Dual PRI card 510 and the HARC card 512 may be a T1/E1 clear channel. By connecting the HARC card 512 with the Dual PRI card 510, modem software changes for the PSTN path may not be necessary, which minimizes the complexity of implementing an Ethernet-based interface. While the HARC card 512 is depicted in a slot adjacent to the Dual PRI card 510, this placement is for the convenience of connecting the two cards and any two card slots in the front plane 502 of the IWF chassis 500 may be used for the Dual PRI card 510 and the HARC card 512.

Other circuit cards, such as Small Computer System Interface (“SCSI”) cards, are also included in the IWF chassis 500. The IWF chassis 500 may also include empty slots, which may be used for future expansion. The IWF chassis 500 may also include power supply units, which provide system power to the circuit cards in the IWF chassis 500.

The IWF chassis 500 includes internal buses used for communications between the circuit cards in the chassis. A packet bus may be included in the IWF chassis 500. The EdgeServer cards 506 may use the packet bus to exchange signaling information and bearer data with the Quad Modem cards 508. The Quad Modem cards 508 may also use the packet bus for signaling with the Dual PRI card 510. A Time Division Multiplex (“TDM”) bus may also be included in the IWF chassis 500. The Dual PRI card 510 may use the TDM bus for communicating with the EdgeServer cards 506 and the Quad Modem cards 508.

The MSC 310 connects to the HARC card 512 in the IWF chassis 500 for the PSTN side of the link. Data exchanged between the PSTN 314 and MSC 310 transmitted over the Ethernet link 406 to the HARC card 512. The HARC card 512 de-packetizes the PSTN data and sends the de-packetized data to the Quad Modem cards 508 via the connection between the Quad T1/E1 NIC card 514 and the Dual PRI card 510. The Dual PRI card 510 receives the de-packetized data as if the data had come from the PSTN 314 over a T1 PRI link and sends the de-packetized data to one of the Quad Modem cards 508 over the TDM bus.

The PSTN data coming from the Quad modem card 508 is sent to the Dual PRI card 510 via the TDM bus. The Dual PRI card 510 transmits the PSTN data to the HARC card 512 over a T1/E1 clear channel via the Quad T1/E1 card 514. The HARC card 512 then packetizes the PSTN data and sends the packetized PSTN data to the MSC 310 over the Ethernet link 406.

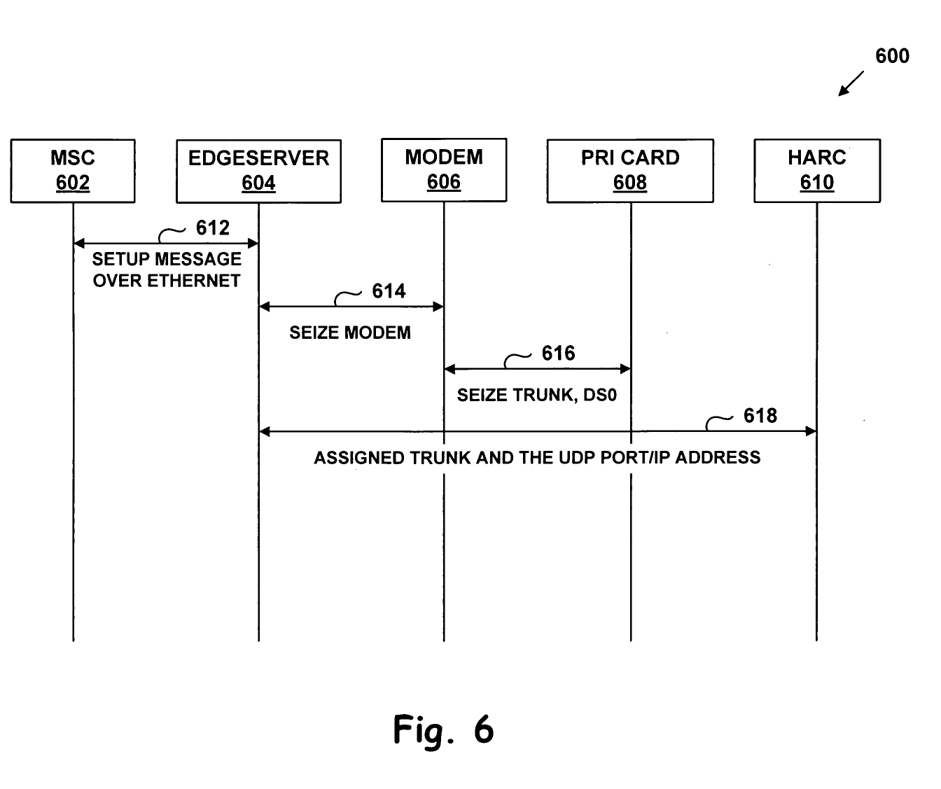

FIG. 6 is a call flow diagram illustrating signaling call flow 600 through the IWF chassis 500 depicted in FIG. 5. The signaling call flow 600 may be used to describe how signaling information regarding a data call is communicated within the IWF chassis 500 prior to the actual bearer data transfer. The signaling call flow 600 depicts communication between an MSC 602, an EdgeServer card 604, a modem card 606, a PRI card 608, and a HARC card 610. The EdgeServer card 604, the modem card 606, the PRI card 608, and the HARC card 610 are located in the IWF chassis 500.

The call flow 600 may begin when the MSC 602 receives a data call from a CDMA telephone, which is to be connected to a terminating device located in the PSTN. Alternatively, the call flow 600 may begin when the MSC 602 receives a data call from a device located in the PSTN, which is to be connected to a terminating device in the wireless network.

The MSC 602 sends a setup message 612 over the Ethernet link 406 to the IWF chassis 500. The setup message 612 may include signaling information. For example, the setup message 612 may contain IP addresses and a UDP port number. The setup message 612 may include an IP address for the MSC 602, the EdgeServer card 604, and/or the HARC card 610. The UPD port number may indicate the port to be used for the bearer data call.

The EdgeServer card 604 receives the setup message 612, and selects a modem on the modem card 606. In addition, the EdgeServer card 604 selects a trunk and a DS0 channel on that truck to be used for communications between the PRI card 608 and the HARC card 610. The EdgeServer card 604 seizes the selected modem 614 in the modem card 606 and provides the modem card 606 information regarding the selected trunk and the DS0 channel. The modem card 606 then seizes 616 the DS0 channel selected by the EdgeServer card 604.

Once the DS0 channel is seized, the EdgeServer card 604 provides the HARC card 610 with the signaling information 618. The EdgeServer card 604 communicates with the HARC card 610 over Ethernet/UDP. The signaling information 618 includes information regarding what trunk and DS0 channel the EdgeServer card 604 selected for the call. Additionally, the signaling information 618 includes the UPD port number assigned to the call and the IP addresses provided by the MSC 602. The IP addresses may be used to determine whether the data is mobile data or PSTN data.

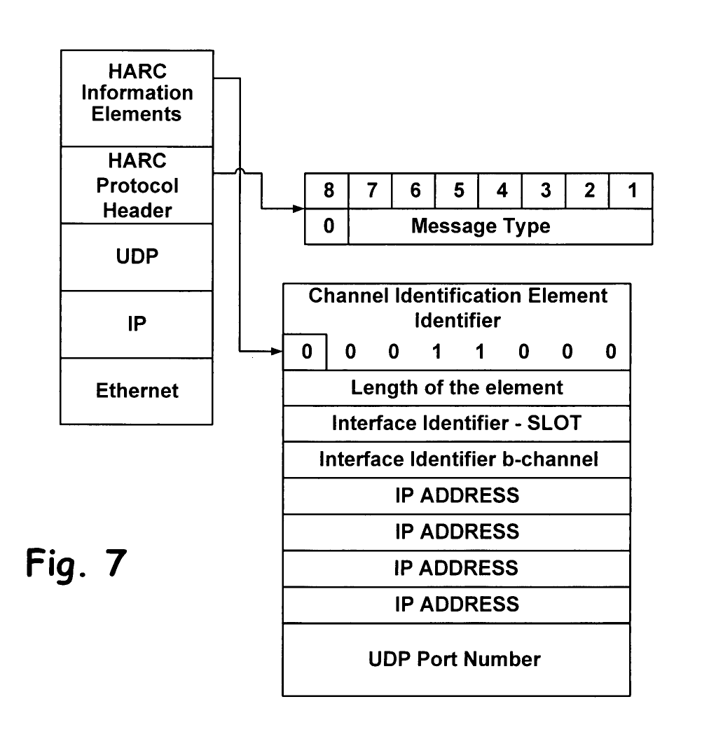

A protocol may be implemented to allow the EdgeServer card 604 to communicate the signaling information 618 to the H-ARC card 610. The protocol may standardize the messaging format between the EdgeServer card 604 and the HARC card 610. For example, a message may include several fields having a predefined order and length. The fields may include trunk, port, and IP address identifications. An example message format is provided in FIG. 7; however, it is understood that other message formats may be used.

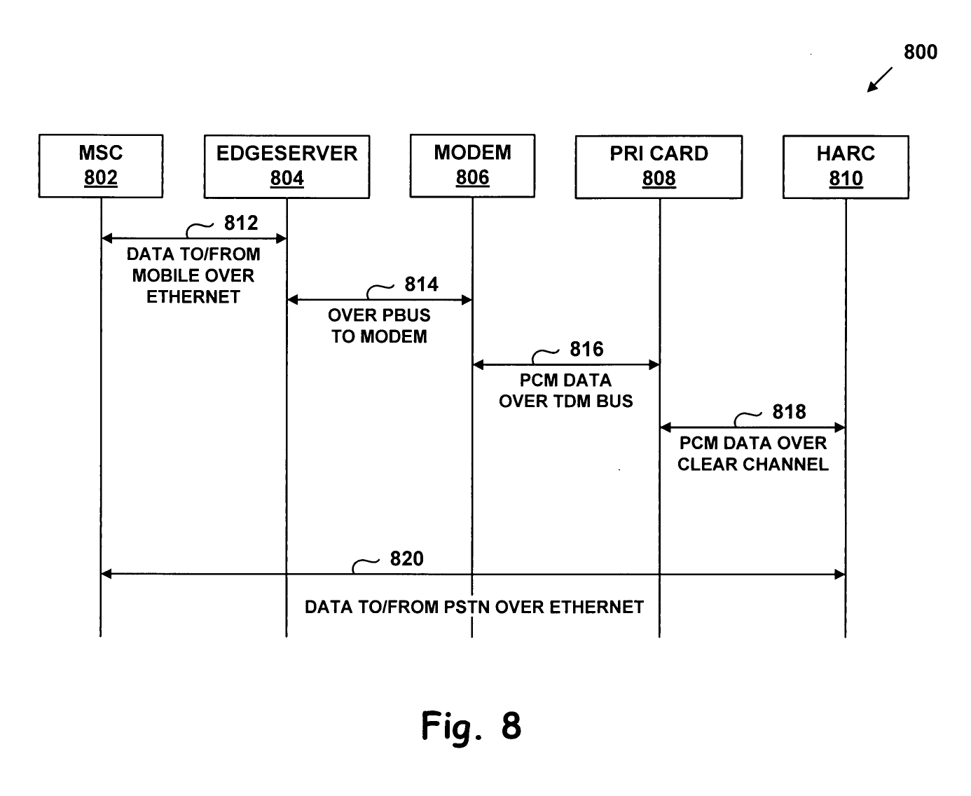

Once the HARC card 610 receives the signaling information, bearer data may be transferred between the MSC 602 and the IWF chassis 500 over the Ethernet link 406. The data communication flow within the IWF chassis 500 is described with reference to FIG. 8.

FIG. 8 is a data flow diagram illustrating data flow 800 through the IWF chassis 500 depicted in FIG. 5. The data flow 800 depicts communication between an MSC 802, an EdgeServer card 804, a modem card 806, a PRI card 808, and a HARC card 810. The EdgeServer card 804, the modem card 806, the PRI card 808, and the HARC card 810 are located in the IWF chassis 500.

The call flow 800 may begin when the MSC 802 receives a data call from a CDMA telephone, which is to be connected to a terminating device located in the PSTN. The MSC 802 sends packetized, unmodulated data to the EdgeServer card 804 over the Ethernet link 406. The EdgeServer card 804 sends the unmodulated payload data over the packet bus 814 to the modem card 806 on the assigned trunk and DS0 channel.

The modem card 806 generates Pulse Code Modulation (PCM) data and sends the PCM data over the TDM bus 816 to the PRI card 808. The PRI card 808 sends the PCM data over a T1/E1 clear channel 818 to the HARC card 810 via a Quad T1/E1 NIC card. The HARC card 810 then packetizes the PCM data and sends the packetized data 820 to the MSC 802 over the Ethernet link 406. The MSC 802 may then send the packetized data to the PSTN. The PSTN may then connect the data call with the terminating device, such as a modem connected to a computer.

The call flow depicted in FIG. 8 may be reversed for calls that originate in the PSTN and terminate in the wireless network. For example, a user device connected to the PSTN may send a data message to a CDMA telephone in a wireless network. In this example, the MSC 802 may receive packetized PCM data from the PSTN. The MSC 802 may send the data 820 from the PSTN to the HARC card 810 over the Ethernet link 406.

The HARC card 810 de-packetizes the PCM data received from the MSC 802 and sends the PCM data via a Quad T1/E1 NIC card to the PRI card 808 over the clear channel 818. The PRI card 808 sends the de-packetized data over the TDM bus 816 to the modem card 806. The modem card 806 demodulates the PCM data and sends the demodulated data to the EdgeServer card 804 via the packet bus. The EdgeServer card 804 then packetizes the demodulated data and sends the data to the MSC 802 over the Ethernet link 406. The MSC 802 may then connect the data call with a terminating device in the wireless network, such as a CDMA telephone.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

1. A system for providing an interface between a wireless switch and an interworking function, comprising in combination:
a wireless switch;
an interworking function; and
an Ethernet link connecting the wireless switch and the interworking function, wherein both signaling information and bearer data are transmitted over the Ethernet link.

2. The system of claim 1, wherein the interworking function includes an Access Router card connected to a Primary Rate Interface card.

3. The system of claim 2, wherein the Access Router card is connected to a Network Interface card that provides an interface between the Access Router card and the wireless switch.

4. The system of claim 2, wherein the Access Router card functions to translate data messages between a wireless network and a Public Switched Telephone Network.

5. The system of claim 4, wherein the Access Router card packetizes data sent from the wireless network to the Public Switched Telephone Network.

6. The system of claim 4, wherein the Access Router card de-packetizes data sent from the Public Switched Telephone Network to the wireless network.

7. The system of claim 1, wherein the interworking function includes a chassis having a Network Interface card, an Access Router card, a Primary Rate Interface card, an application card, and a modem card.

8. The system of claim 7, wherein the application card provides signaling information to the Access Router card using a signaling protocol.

9. The system of claim 8, wherein the signaling protocol provides a method of transferring trunk, port, and IP address information from the application card to the Access Router card.

10. The system of claim 9, wherein the IP address information includes an IP address of the wireless switch, an IP address of the application card, an IP address of the Access Router card, and a UDP port number to be used for data exchange between the Access Router card and the wireless switch.

11. A system for providing an interface between a wireless switch and an interworking function, comprising in combination:
a wireless switch;
an interworking function having a chassis including a Network Interface card, an Access Router card, a Primary Rate Interface card, an application card, and a modem card, wherein the Access Router card is connected to the Primary Rate Interface card in the chassis, wherein the application card communicates with the Access Router card using a signaling protocol that provides a method of transferring trunk, port, and IP address information from the application card to the Access Router card; and
an Ethernet link connecting the wireless switch and the interworking function, wherein both signaling information and bearer data are transmitted over the Ethernet link.

12. A method for providing an interface between a wireless switch and an interworking function, comprising in combination:
connecting an Ethernet link between a wireless switch and an interworking function, wherein both signaling information and bearer data are transmitted over the Ethernet link;
connecting an Access Router card to a Primary Rate Interface card within the interworking function, wherein the Access Router card de-packetizes data from a Public Switched Telephone Network prior to transmitting the data to a wireless network, wherein the Access Router card packetizes data from the wireless network prior to transmitting the data to the Public Switched Telephone Network; and
providing a signaling protocol for an application card in the interworking function to transfer signaling information to the Access Router card.

13. The method of claim 12, further comprising removing T1/E1 trunks between the wireless switch and the interworking function.

14. The method of claim 12, wherein the signaling information includes trunk, port, and IP address information.

15. The system of claim 14, wherein the IP address information includes an IP address of the wireless switch, an IP address of the application card, an IP address of the Access Router card, and a UDP port number to be used for data exchange between the Access Router card and the wireless switch.

16. A method for providing an interface between a wireless switch and an interworking function, comprising in combination:
receiving signaling information over an Ethernet link;
assigning a trunk for bearer data transmission;
sending trunk, port, and IP address information to an Access Router card;
receiving bearer data over the Ethernet link;
translating the bearer data; and
transmitting the translated bearer data over the Ethernet link.

17. The method of claim 16, wherein the step of receiving signaling information over an Ethernet link includes receiving port and IP address information into an application card.

18. The method of claim 17, wherein the IP address information includes an IP address of the wireless switch, an IP address of the application card, an IP address of the Access Router card, and a UDP port number to be used for data exchange between the Access Router card and the wireless switch.

19. The method of claim 16, wherein the step of assigning a trunk for bearer data transmission includes an application card selecting the trunk.

20. The method of claim 16, wherein the step of sending trunk, port, and IP address information to an Access Router card includes an application card sending the trunk, port, and address information to the Access Router card using a signaling protocol.

21. The method of claim 16, wherein the step of receiving bearer data over the Ethernet link, includes the Access Router card receiving the bearer data from a Public Switched Telephone Network via the wireless switch.

22. The method of claim 16, wherein the step of receiving bearer data over the Ethernet link, includes an application card receiving the bearer data from a wireless network via the wireless switch.

23. The method of claim 16, wherein the step of translating the bearer data includes demodulating data received from a Public Switched Telephone Network to be delivered to a wireless network.

24. The method of claim 16, wherein the step of translating the bearer data includes modulating data received from a wireless network to be delivered to the Public Switched Telephone Network.

25. The method of claim 16, wherein the step of transmitting the translated bearer data over the Ethernet link includes the Access Router card transmitting the translated bearer data to a Public Switched Telephone Network via the wireless switch.

25. The method of claim 16, wherein the step of transmitting the translated bearer data over the Ethernet link includes an application card transmitting the translated bearer data to a wireless network via the wireless switch.

26. A method of routing calls, comprising in combination:
assigning a UDP port number to a bearer data call between a wireless switch and an interworking function;
providing an IP address indicating a type of data for the bearer data call; and
packetizing bearer data, wherein the packets include the assigned UPD port number and the IP address.

27. The method of claim 26, wherein providing an IP address of an application card indicates that the type of data is mobile data.

28. The method of claim 26, wherein providing an IP address of an Access Router card indicates that the type of data is Public Switched Telephone Network data.

29. An interworking function having an Ethernet interface for receiving and sending packetized data to a wireless switch, comprising in combination:
a Network Interface card connected to the wireless switch, an Access Router card connected to the Network Interface card;
a Primary Rate Interface card connected to the Access Router card;
a modem card connected to the Primary Rate Interface card; and
an application card connected to the modem card, wherein the application card receives signaling information from the wireless switch and provides the signaling information to the Access Router card.

30. The system of claim 29, wherein the Access Router card packetizes data sent from the wireless switch destined for a Public Switched Telephone Network.

31. The system of claim 29, wherein the Access Router card de-packetizes data sent from the wireless switch destined for a wireless network.

32. The system of claim 29, wherein the modem card demodulates data received from the wireless switch to be delivered to a wireless network.

33. The system of claim 29, wherein the modem card modulates data received from the wireless switch to be delivered to the Public Switched Telephone Network.
